(19) United States
(12) Patent Application Publication
(10) Pub. No.: US 2014/0285366 A1
(43) Pub. Date: Sep. 25, 2014

(54) METHOD AND SYSTEM FOR FINGERLINE (PHALANGE) MAPPING TO AN INPUT DEVICE OF A COMPUTING DEVICE

(71) Applicant: Unisys Corporation, Blue Bell, PA (US)

(72) Inventor: Kenneth R. D'Souza, Bangalore (IN)

(73) Assignee: Unisys Corporation, Blue Bell, PA (US)

(21) Appl. No.: 13/847,086

(22) Filed: Mar. 19, 2013

(51) Int. Cl. G06F 3/023

(52) U.S. Cl. CPC G06F 3/0238
USPC 341/23

(57) ABSTRACT

A method and system for mapping characters of an input device of a computing device to fingerline positions of a user. The method includes embedding at least one character corresponding to the input device of the computing device to a fingerline position, The method also includes registering a character corresponding to the input device of the computing device using a designated registration fingerline position, wherein the designated registration fingerline position does not have any characters embedded thereto.

### BACKGROUND

1. Field

The instant disclosure relates generally to fingerline (phalange) mapping, and more particularly, to fingerline (phalange) mapping to an input device of a computing device.

2. Description of the Related Art

In the usage of computing devices, one common input device is the standard keyboard, which has alpha, numeric and special characters. It is assumed that in typical written communication at least these alpha, numeric and special characters are to be frequently used and hence present on the keyboard associated with the computing device. Also, in non verbal communication, these characters or symbols corresponding to these characters are mapped to gestures of hands. For example, these gestures are known by a particular set of physically challenged people, e.g., hearing impaired people.

In general, there may not be much reason or motivation for non-physically challenged people to learn these gestures unless otherwise to teach or understand what physically challenged people want to communicate. One of the reasons for non-physically challenged people to not learn these gestures could be that these gestures require additional learning and can be relatively time consuming. Also, these gestures typically are known only by a particular set of physically challenged people (e.g., hearing impaired people), which often number far less than non-physically challenged people and other denominations of physically challenged people, e.g., vision impaired people and autistic people

Accordingly, there is not a common and relatively easily adaptable platform that can be used by both physical and non-physical challenged people.

### SUMMARY

Disclosed is a method and system for mapping characters of an input device of a computing device to fingerline positions of a user. The method includes embedding at least one character corresponding to the input device of the computing device to a fingerline position. The method also includes registering a character corresponding to the input device of the computing device using a designated registration fingerline position, wherein the designated registration fingerline position does not have any characters embedded thereto.

### BRIEF DESCRIPTION OF THE DRAWINGS

FIG. 1 is a schematic view of user fingerline positions, according to an embodiment;

FIG. 2 is a schematic view of a set of input device character representations corresponding to user fingerline positions, according to an embodiment;

FIG. 3 is a schematic view of an alternative set of input device character representations corresponding to user fingerline positions, according to an embodiment;

FIG. 4 is a flow diagram of a method for fingerline (phalange) mapping of an input device of a computing device, according to an embodiment; and

FIG. 5 is a schematic diagram of a system for fingerline (phalange) mapping of an input device of a computing device, according to an embodiment.

### DETAILED DESCRIPTION

In the following description, like reference numerals indicate like components to enhance the understanding of the disclosed method and apparatus for providing low latency communication/synchronization between parallel processes through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the disclosure.

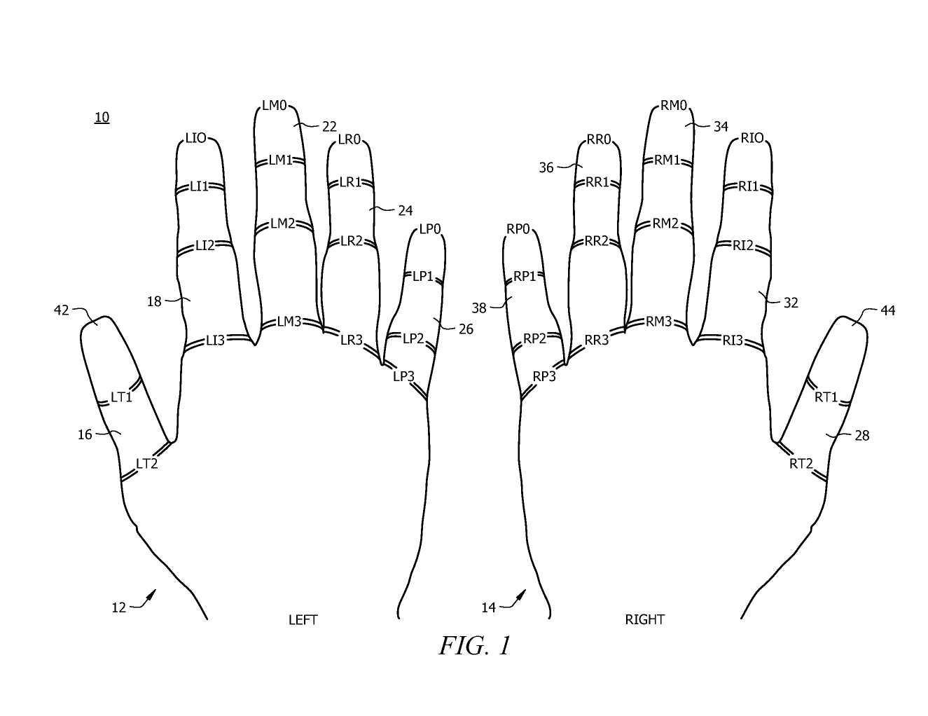

FIG. 1 is a schematic view 10 of user fingerline positions, according to an embodiment. The fingerline positions correspond to various positions on a left hand 12 of a user and a right hand 14 of a user, e.g., at the various joints of the fingers. As shown, the fingerline positions are represented by a suitable notation scheme. For example, the fingerlines are represented in notation form in the order of the left or right hand, the finger on which the fingerline is present and the vertical joint position of the fingerline moving from the tip of the finger numbered at the position zero.

In general, the left hand 12 is notated by “L” and the right hand 14 is notated by “R.” Fingers of each hand are represented by Thumb (T), Index (I), Middle (M), Ring (R) and Pinky (P). In this particular fingerline notation scheme, there is no representation of the thumb finger tip. Finger tip positions are notated by “0,” and fingerline (phalange) positions are notated by “1”,“2” and “3,” moving downward from the tip of the finger toward the palm of the hand. As will be discussed in greater detail hereinbelow, in this particular fingerline notation scheme, the tip of thumb each of the left hand 12 and the right hand 14 is a designated pointing or registration fingerline position.

Therefore, in this particular fingerline notation scheme, a thumb 16 of the left hand 12 has a first fingerline notation LT1 and a second fingerline notation LT2. An index finger 18 of the left hand 12 has a tip fingerline notation LI0, a first fingerline notation LI1, a second fingerline notation LI2 and a third fingerline notation LI3. A middle finger 22 of the left hand 12 has a tip fingerline notation LM0, a first fingerline notation LM1, a second fingerline notation LM2 and a third fingerline notation LM3. A ring finger 24 of the left hand 12 has a tip fingerline notation LR0, a first fingerline notation LR1, a second fingerline notation LR2 and a third fingerline notation LR3. A pinky finger 26 of the left hand 26 has a tip fingerline notation LP0, a first fingerline notation LP1, a second fingerline notation LP2 and a third fingerline notation LP3.

For the right hand 14, a thumb 28 of the right hand 14 has a first fingerline notation RT1 and a second fingerline notation RT2. An index finger 32 of the right hand 14 has a tip fingerline notation RI0, a first fingerline notation RI1, a second fingerline notation RI2 and a third fingerline notation RI3. A middle finger 34 of the right hand 14 has a tip fingerline notation RM0, a first fingerline notation RM1, a second fingerline notation RM2 and a third fingerline notation RM3. A ring finger 36 of the right hand 14 has a tip fingerline notation RR0, a first fingerline notation RR1, a second fingerline notation RR2 and a third fingerline notation RR3. A pinky finger 38 of the right hand 14 has a tip fingerline notation RP0, a first fingerline notation RP1, a second fingerline notation RP2 and a third fingerline notation RP3.

It should be understood that other suitable fingerline notation schemes can be used to represent the various user fingerline positions.

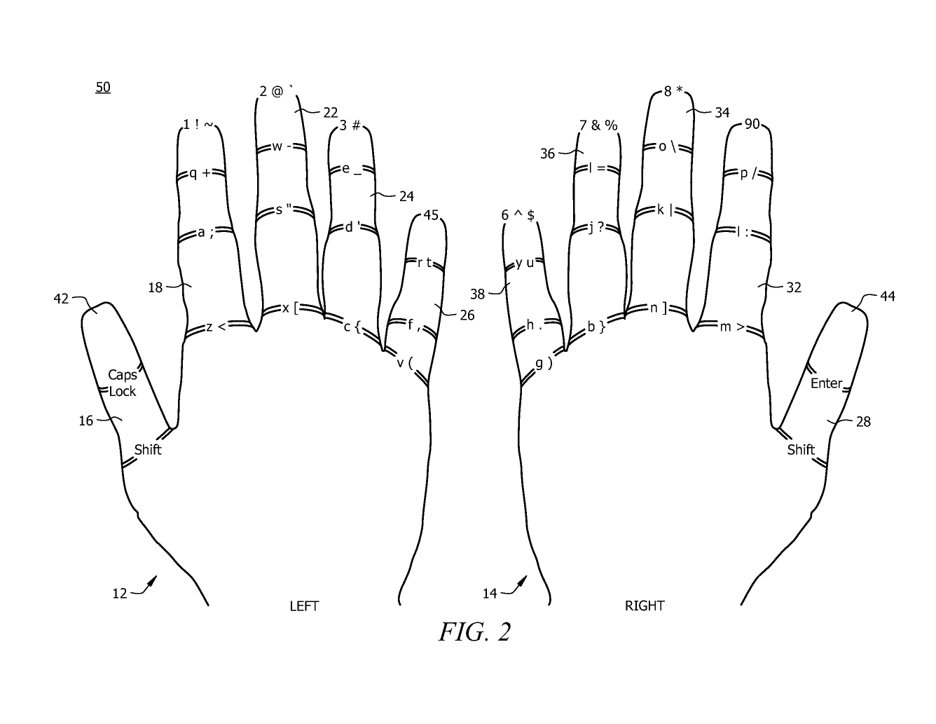

FIG. 2 is a schematic view 50 of a set of input device character representations corresponding to user fingerline positions, according to an embodiment, in this particular set of input device character representations, a QWERTY keyboard input device is taken as a reference for mapping. It should be understood that other keyboard, keypad and other input device layouts can be used for mapping, including the layouts of non-English language keyboards, keypads and input devices.

In this particular character representation, character digits correspond to or are placed on the tips of the fingers in the manner they occur on a standard QWERTY keyboard, with the exceptions that the tip fingerline position of the pinky 26 on the left hand 12 (LP0) has the character digits “4” and “5” and the tip fingerline position of the index finger 32 on the right hand 14 (RI0) has the character digits “9” and “0.” The other characters correspond to or are placed on the finger lines in the manner they occur on a standard QWERTY keyboard, with the exceptions that the first fingerline position of the pinky 26 of the left hand 12 (LP1) has the characters “R” and “T,” the first fingerline position of the pinky 38 of the right hand 14 (RP1) has the characters “Y” and “U,” and the third fingerline position of the pinky 38 of the right hand 14 (RP3) has the character “G.”

The special characters above the numerals in the QWERTY keyboard layout correspond to or are placed in the same relative positions as they occur in the QWERTY keyboard layout, with the exceptions that the tip fingerline position of the pinky 38 of the right hand 14 (RP0) has the “$” special character, the tip fingerline position of the ring finger 36 of the right hand 14 (RR0) has the “%” special character, the third fingerline position of the pinky 26 of the left hand 12 (LP3) has the “(” special character, and the third fingerline position of the pinky 38 of the right hand 14 (RP3) has the “)” special character. Thus, the special characters “$” and “%” are the third characters on their respective finger tip fingerline positions. Also, the first fingerline position of the index finger 18 of the left hand 12 (LI1) has the “+” special character, the first fingerline position of the middle finger 22 of the left hand 12 (LM1) has the “−” special character, the first fingerline position of the ring finger 24 of the left hand 12 (LR1) has the “_” special character, the first fingerline position of the ring finger 36 of the right hand 14 (RR1) has the “=” special character, the first fingerline position of the middle finger 34 of the right hand 14 (RM1) has the “\” special character, and the first fingerline position of the index finger 32 of the right hand 14 (RI1) has the “/” special character.

Therefore, in this particular character representation scheme, the fingerline representations have a symmetric pattern of alpha and numeric characters at theft respective positions between the left hand 12 and the right hand 14. Moreover, the special characters of opposite characteristics are placed together for the ease of remembrance, e.g., the index finger 18 and the middle finger 22 of the left hand 12 have the “+” special character and the “−” special character, respectively, and the ring finger 36 and the pinky finger 38 have the “\” special character and the “/” special character, respectively.

Also, in this particular character representation scheme, the second fingerline position of the index finger 18 of the left hand 12 (LI2) has the “;” special character, the second fingerline position of the middle finger 22 of the left hand 12 (LM2) has the “″” double quotes special character, and the second fingerline position of the ring finger 24 of the left hand 12 (LR2) has the “′” single quote special character. Also, the second fingerline position of the index finger 32 of the right hand 14 (RI2) has the “:” special character, the second fingerline position of the middle finger 34 of the right hand 14 (RM2) has the “|” special character, the second fingerline position of the ring finger 36 of the right hand 14 (RR2) has the “?” special character, and the second fingerline position of the pinky finger 38 of the right hand 14 (RP2) has the “.” special character. This portion of the fingerline representation does not follow any special pattern or symmetry, except that the “.” special character and the “,” special character are placed in the different hands and at a convenient fingerline position as they are used quite often in the English language.

In this particular character representation scheme, the third fingerline position of the index finger 18 of the left hand 12 (LI3) has the “<” special character, the third fingerline position of the middle finger 22 of the left hand 12 (LM3) has the “[” special character, the third fingerline position of the ring finger 24 of the left hand 12 (LR3) has the “{” special character, and the third fingerline position of the pinky finger 26 of the left hand 12 (LP3) has the “(” special character. Also, the third fingerline position of the index finger 32 of the right hand 14 (RI3) has the “>” special character, the third fingerline position of the middle finger 34 of the right hand 14 (RM3) has the “]” special character, the third fingerline position of the ring finger 36 of the right hand 14 (RR3) has the “}” special character, and the third fingerline position of the pinky finger 38 of the right hand 14 (RP3) has the “)” special character. Therefore, this portion of the fingerline representation has a symmetric pattern of opposite special characters at their respective positions between the left and the right hand.

In this particular character representation scheme, the tip fingerline position of the index finger 18 of the left hand 12 (LI0) has the “˜” special character, and the tip fingerline position of the middle finger 22 of the left hand 12 (LM0) has the “'” special character. Also, the first fingerline position of the thumb 16 of the left hand 12 (LT1) has the “Caps Lock” representation, and the second fingerline position of the thumb 16 of the left hand 12 (LT2) has the “Shift” representation. Also, the first fingerline position of the thumb 28 of the right hand 14 (RT1) has the “Enter” representation, and the second fingerline position of the thumb 28 of the right hand 14 (RT2) has the “Shift” representation.

The tip 42 of the thumb 16 of the left hand 12 and the tip 44 of the thumb 28 of the right hand 14 are not associated with any alpha, number or special characters, because, as discussed hereinabove, the tips of the thumbs are used as the designated pointing and/or registration fingerline positions.

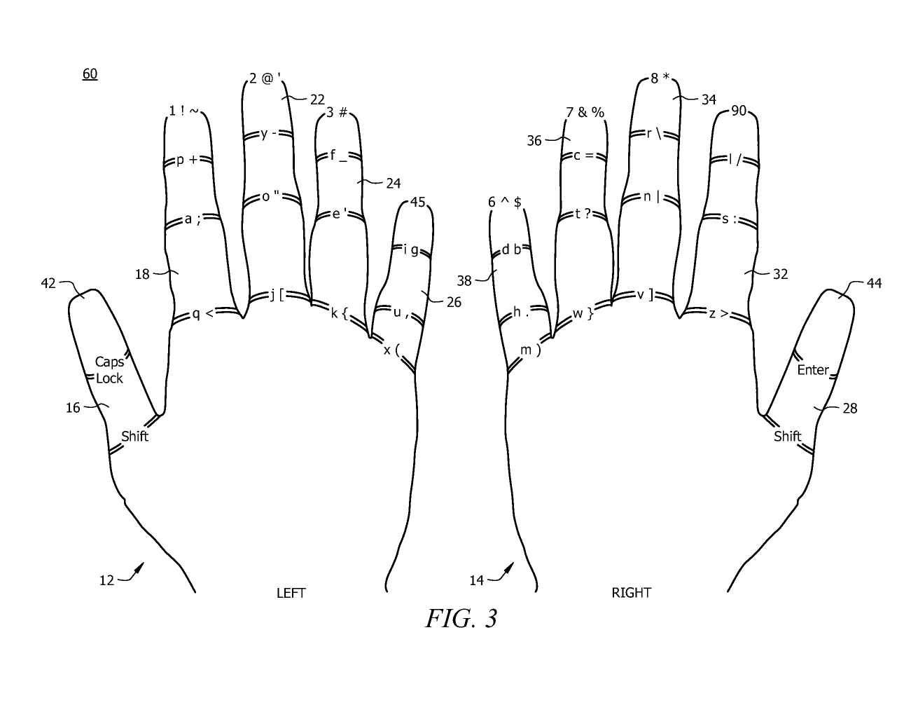

FIG. 3 is a schematic view 60 of an alternative set of input device character representations corresponding to user fingerline positions, according to an embodiment. In this particular set of input device character representations, a DVORAK keyboard input device is taken as a reference for mapping. It should be understood that other keyboard, keypad and other input device layouts, such as a QWERTZ keyboard input device, can be used for mapping.

In the particular character representation scheme shown in FIG. 3, there are relatively few modifications from a standard DVORAK keyboard input device. For example, the first fingerline position of the pinky finger 26 of the left hand 12 (LP1) has the characters “i” and “g” because the character “i” typically is used more frequently than the character “g.” In standard DVORAK mapping, the first fingerline position of the pinky finger 26 of the left hand 12 (LP1) could have the characters “g” and “i.” Also, the first fingerline position of the pinky finger 38 of the right hand 14 (RP1) has the characters “d” and “b.”

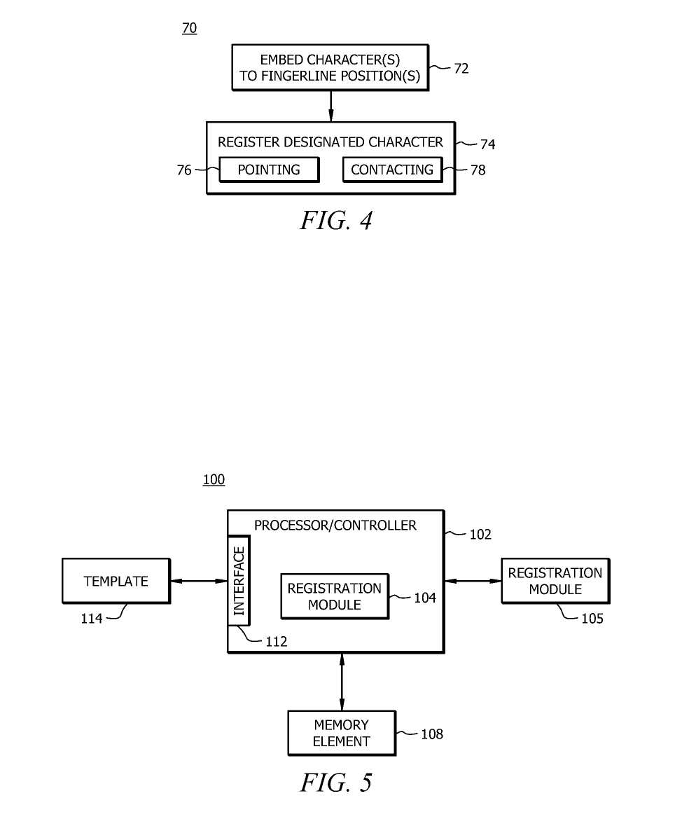

FIG. 4 is a flow diagram of a method 70 for fingerline (phalange) mapping of an input device of a computing device, according to an embodiment. The method 70 includes a step 72 of embedding or associating one or more characters to a fingerline position. As discussed hereinabove, the association of one or more characters to a fingerline position can be based on a QWERTY keyboard input device to a computing device. Alternatively, the association of one or more characters to a fingerline position can be based on a DVORAK or QWERTZ keyboard input device to a computing device.

The method 70 also includes a step 74 of registering a designated character by using a designated registration fingerline position. As discussed hereinabove, the tip of the thumb of the left hand and the tip of the thumb of the right hand can be used as the designated registration fingerline position, as neither the tip of the thumb of the left hand nor the tip of the thumb of the right hand has any characters embedded thereto.

The registration of a designated character can be accomplished by pointing 76 the designated registration fingerline position, e.g,, the tip of the thumb, at the fingerline position embedded with the designated character. Alternatively, the registration of a designated character can be accomplished by contacting 78 the designated registration fingerline position, e.g., the tip of the thumb, with the fingerline position embedded with the designated character.

More specifically, to register a designated character, the tip of the thumb of the appropriate hand points to or contacts the fingerline position associated with the designated character. To register the second character associated with a particular fingerline position or location, the tip of the thumb of the appropriate hand points to or contacts the designated fingerline position associated with the designated character, along with the tip of any finger of the other hand pointing to or contacting the “Shift” fingerline position of the other hand, e.g., the second fingerline position of the thumb 16 of the left hand 12 (LT2) or the second fingerline position of the thumb 28 of the right hand 14 (RT2).

For example, using the mapping representation shown in FIG. 2, to register a designated character “r,” the tip 42 of the thumb 16 of the left hand 12 or the tip 44 of the thumb 28 of the right hand 14 points to or contacts the first fingerline position of the pinky finger 26 of the left hand 12 (LR2). To register a designated character “t” the tip 42 of the thumb 16 of the left hand 12 points to or contacts the first fingerline position of the pinky finger 26 of the left hand 12 (LR2) along with the tip of one of the fingers of the right hand 14 pointing to or contacting the second fingerline position (Shift) of the thumb 28 of the right hand 14 (RT2). Alternatively, the tip of the thumb of one hand can be used to point to or contact the “Shift” fingerline position of the other hand, if convenient.

The possible exceptions to this registration procedure would be for fingerline positions that have three characters associated therewith. In such cases, the registration of the third character of a particular fingerline position would involve the particular fingerline location of the associated third character being pointed to or contacted twice in quick succession along with the “Shift” position also being pointed to or contacted.

To register the “Backspace” character or function, both “Shift” fingerline positions are pointed to one another or contacted together. Also, in some character representations, the “ALT” and “CTRL” character functions are not accommodated.

As will be discussed in greater detail hereinbelow, the fingerline representation or notation scheme can be configured as part of a template or set of templates, or other suitable device or devices, such as a set of gloves, that have suitable electronics or other registration means coupled to a controller or processor that enables the representation or registration of a corresponding character with the controller or processor in response to pointing and/or contact by a designated registration fingerline position. For example, see U.S. nonprovisional application for patent entitled “METHOD AND SYSTEM FOR KEYGLOVE FINGERMAPPING AN INPUT DEVICE OF A COMPUTING DEVICE,” filed on ______, 2012, and assigned application Ser. No. __/___,___.

For example, in the particular fingerline schemes shown, the designated registration fingerline position is the tip 42 of the thumb 16 of the left hand 12 and the tip 44 of the thumb 28 of the right hand 14. That is, when either the tip 42 of the thumb 16 of the left hand 12 or the tip 44 of the thumb 28 of the right hand 14 points to and/or contacts a fingerline position, the corresponding character associated with that fingerline position is represented or registered by the controller or processor.

FIG. 5 is a schematic diagram of a system 100 for fingerline (phalange) mapping of an input device of a computing device, according to an embodiment. The system 100 can be any apparatus, device or computing environment suitable for providing fingerline (phalange) mapping of an input device of a computing device according to an embodiment. For example, the system 100 can be or be contained within any suitable computer system, including a mainframe computer and/or a general or special purpose computer.

The system 100 includes one or more general purpose (host) controllers or processors 102 that, in general, processes instructions, data and other information received by the system 100. The processor 102 also manages the movement of various instructional or informational flows between various components within the system 100. The processor 102 can include a registration module 104 that is configured to execute and perform the fingerline mapping of an input device of a computing device processes described herein. Alternatively, the system 100 can include a standalone registration module 105 coupled to the processor 102.

The system 100 also can include a memory element or content storage element 106, coupled to the processor 102, for storing instructions, data and other information received and/or created by the system 100. In addition to the memory element 108, the system 100 can include at least one type of memory or memory unit (not shown) within the processor 102 for storing processing instructions and/or information received and/or created by the system 100.

The system 100 also can include one or more interfaces 112 for receiving instructions, imagery, data and other information, e.g., from a mapping template 114 or other suitable mapping means described herein. It should be understood that the interface 112 can be a single input/output interface, or the system 100 can include separate input and output interfaces.

One or more of the processor 102, the registration module 104, the registration module 105, the memory element 108 and the interface 112 can be comprised partially or completely of any suitable structure or arrangement, e.g., one or more integrated circuits. Also, it should be understood that the system 100 includes other components, hardware and software (not shown) that are used for the operation of other features and functions of the system 100 not specifically described herein.

The system 100 can be partially or completely configured in the form of hardware circuitry and/or other hardware components within a larger device or group of components. Alternatively, the processes performed by the system 100 can be partially or completely configured in the form of software, e.g., as processing instructions and/or one or more sets of logic or computer code. In such configuration, the logic or processing instructions typically are stored in a data storage device, e.g., the memory element 108 or other suitable data storage device (not shown). The data storage device typically is coupled to a processor or controller, e.g., the processor 102. The processor accesses the necessary instructions from the data storage element and executes the instructions or transfers the instructions to the appropriate location within the system 100.

One or more of the registration module 104 and the registration module 105 can be implemented in software, hardware, firmware, or any combination thereof. In certain embodiments, the module(s) may be implemented in software or firmware that is stored in a memory and/or associated components and that are executed by the processor 102, or any other processor(s) or suitable instruction execution system. In software or firmware embodiments, the logic may be written in any suitable computer language. One of ordinary skill in the art will appreciate that any process or method descriptions associated with the operation of the registration module 104 and the registration module 105 may represent modules, segments, logic or portions of code which include one or more executable instructions for implementing logical functions or steps in the process. It should be further appreciated that any logical functions may be executed out of order from that described, including substantially concurrently or in reverse order, depending on the functionality involved, as would be understood by those reasonably skilled in the art. Furthermore, the modules may be embodied in any non-transitory computer readable medium for use by or in connection with an instruction execution system, apparatus, or device, such as a computer-based system, processor-containing system, or other system that can fetch the instructions from the instruction execution system, apparatus, or device and execute the instructions.

One or more of the controller and processor can be comprised partially or completely of any suitable structure or arrangement, e.g., one or more integrated circuits. Also, it should be understood that the computing device shown include other components, hardware and software (not shown) that are used for the operation of other features and functions of the computing devices not specifically described herein.

The functions described herein may be implemented in hardware, software, firmware, or any combination thereof, If implemented in software, the functions may be stored on or transmitted as one or more instructions or code on a non-transitory computer-readable medium. The methods illustrated in the figures may be implemented in a general, multi-purpose or single purpose processor. Such a processor will execute instructions, either at the assembly, compiled or machine-level, to perform that process. Those instructions can be written by one of ordinary skill in the art following the description of the figures and stored or transmitted on a non-transitory computer readable medium. The instructions may also be created using source code or any other known computer-aided design tool. A non-transitory computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), and the like.

It will be apparent to those skilled in the art that many changes and substitutions can be made to the embodiments described herein without departing from the spirit and scope of the disclosure as defined by the appended claims and their full scope of equivalents.

1. A method for mapping characters of an input device of a computing device to fingerline positions of a user, the method comprising:
embedding at least one character corresponding to the input device of the computing device to a fingerline position; and
registering a character corresponding to the input device of the computing device using a designated registration fingerline position, wherein the designated registration fingerline position does not have any characters embedded thereto.

2. The method as recited in claim 1, wherein registering a character corresponding to the input device of the computing device with the designated registration fingerline position includes pointing the designated registration fingerline position to at least one of the fingerline positions having the character embedded thereto.

3. The method as recited in claim 1, wherein registering a character corresponding to the input device of the computing device with a designated registration fingerline position includes contacting the designated registration fingerline position with at least one of the fingerline positions having the character embedded thereto.

4. The method as recited in claim 1, wherein the characters include standard characters and special shift characters, and wherein a standard character is registered by registering the fingerline position corresponding to the standard character with the designated registration fingerline position.

5. The method as recited in claim 1, wherein the characters include standard characters and special shift characters, and wherein a special shift character is registered by registering a shift fingerline position with the designated registration fingerline position and then by registering the special shift character with the designated registration fingerline position.

6. The method as recited in claim 1, wherein at least one of the fingerline positions corresponds to a joint of a finger of the user.

7. The method as recited in claim 1, wherein at least one of the fingerline positions corresponds to a finger tip of the user.

8. The method as recited in claim 1, wherein at least one of the fingerline positions has a plurality of characters embedded thereto.

9. The method as recited in claim 1, wherein the input device is one of a QWERTY keyboard, a DVORAK keyboard and a QWERZ keyboard.

10. A system for mapping characters of an input device of a computing device to fingerline positions of a user, the system comprising:
a template having embedded therein at least one character corresponding to the input device of the computing device to a fingerline position, the template including at least one designated registration fingerline position that does not have any characters embedded thereto; and
a processor coupled to the template and configured to register a character corresponding to the input device of the computing device using the designated registration fingerline position.

11. The system as recited in claim 10, wherein the processor registers a character corresponding to the input device of the computing device when the designated registration fingerline position points to at least one of the fingerline positions having the character embedded thereto.

12. The system as recited in claim 10, wherein the processor registers a character corresponding to the input device of the computing device when the designated registration fingerline position contacts at least one of the fingerline positions having the character embedded thereto.

13. The system as recited in claim 10, wherein the characters include standard characters and special shift characters, and wherein the processor registers a standard character by registering the fingerline position corresponding to the standard character using the designated registration fingerline position.

14. The system as recited in claim 10, wherein the characters include standard characters and special shift characters, and wherein the processor registers a special shift character by registering a shift fingerline position with the designated registration fingerline position and then by registering the special shift character with the designated registration fingerline position.

15. The system as recited in claim 10, wherein at least one of the template fingerline positions corresponds to a joint of a finger of the user.

16. The system as recited in claim 10, wherein at least one of the fingerline positions corresponds to a finger tip of the user.

17. The system as recited in claim 10, wherein at least one of the template fingerline positions has a plurality of characters embedded thereto.

18. The system as recited in claim 9, wherein the input device is one of a QWERTY keyboard, a DVORAK keyboard and a QWERZ keyboard.
